(19) United States
(12) Patent Application Publication
(10) Pub. No.: US 2005/0099409 A1
(43) Pub. Date: May 12, 2005

(54) Digital pen and paper system

(76) Inventor: Patrick Brouhon, Saint Martin d'Uriage (FR)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/938,867

(22) Filed: Sep. 9, 2004

(30) Foreign Application Priority Data
Sep. 10, 2003 (GB) 0321176.0

(51) Int. Cl. G09G 1/28; G09G 5/00

(52) U.S. Cl. 345/179

(57) ABSTRACT

A digital pen and paper system comprises a digital pen adapted to acquire information from a position-determining pattern printed on a carrier and a base station which is arranged to receive information from the pen and to send the information across a telecommunications network to a remote device, the base station having a dedicated processor and program instructions adapted to receive information from the pen. The base station comprises a self-contained unit which includes a modem for connection to a remote device across a land-based telecommunications network. It may be configured remotely from across the network by the same remote device to which it will send pen information.

### FIELD OF THE INVENTION

This invention relates to digital pen and paper, sometimes called pen computing, systems where a pen is used to read a pattern of position identification markings printed on digital documents.

### BACKGROUND OF THE INVENTION

Many digital pen and paper systems have been proposed. Few have been used on any commercial scale. One that is in use is the Anoto system, which can be implemented using a device such as the Logitech IO™ pen, available from Logitech of 6505 Kaiser Drive, Fremont, Calif. 94555, USA. The invention will be described in relation to that kind of technology, and is especially, but not exclusively, applicable to arrangements where the pen sees a position determining pattern that has been printed onto the page and in which an evaluation of the pen's position, and movements, is made using data collected by the pen. WO 03/046708 discloses a system of this kind and its content is incorporated into this disclosure by reference.

In the known Anoto type arrangements, the pen is connected by a Universal Serial Bus (USB) cable or wirelessly to a processing device such as a mobile telephone or a personal computer. The processing device receives data from the pen and sends the data across a network to a server on which digital paper information is stored. The server identifies the document which has been marked by the pen and returns to the processing device information about how the document should be handled. This information may identify an application, perhaps stored on the processing device or held remotely, which enables the information from the pen to be processed.

### SUMMARY OF THE INVENTION

According to a first aspect the invention comprises a digital pen and paper system comprising:
a digital pen adapted to acquire information from a position-determining pattern printed on digital paper to enable the position of the pen to be determined, the pen having a writing stylus adapted to write handwritten markings onto the paper and being adapted to capture those handwritten markings digitally, and
a base station which is specifically arranged to receive information from the pen and to send the information across a telecommunications network to a remote device, the base station having a dedicated processor and program instructions adapted to receive information from the pen.

The base station may comprise a compact, self-contained, palm sized housing, which may contain a processor, a memory which stores the instructions to be executed by the processor and a modem for sending and/or receiving data across the telecommunications network (typically a land-based telephone network). It will also contain a communication means which enables the station to receive the digitally captured handwritten markings from the pen.

Such a system lends itself well to low cost applications, as in its most simple form the base station does not need to be able to do anything beyond communicate pen information between the pen and a remote device across the telecommunications network. A device of this type can be produced relatively inexpensively. For example, the device could be supplied to a participant in a medical trial who may use the pen to log information about the trial. The base station would then send the information to a remote device operated by the trials organisers. A low cost device would enable a large number of participants to be provided with devices whilst keeping the costs of the trial within an acceptable budget.

The skilled man will appreciate that the term modem is intended to cover any device which sends and/or receives information across a telecommunications network, most typically a land-line telephone network.

Providing a dedicated, self contained base station which is specifically adapted to receive information from a digital pen and pass it out to a remote server via an internal modem across a telecommunications network means that the user does not need to connect the pen to a relatively expensive personal computer. It may also, in some arrangements, avoid the need to connect to the server across an expensive mobile telephone network connection as is the case with the use of a mobile telephone to read the pen information. The user can, in at least one example within the scope of the present invention simply plug the base station into a telephone socket and start writing with the pen.

The base station may include a base portion for supporting the pen when not in use. It may also comprise a charger for the pen, with the pen including one or more rechargeable batteries. Contacts on the base station may be arranged to provide an electrical connection to complimentary contacts on the pen to facilitate charging. It may, in an alternative, charge the pen inductively provided the electronics within the pen can be designed to consume a low enough amount of power during use to give an acceptable working life between recharging.

Unlike prior art systems based around a personal computer, the base station may be free from any form of user interface other than perhaps a simple light to indicate that the base station is operational and/or perhaps that it is transmitting and/or receiving information. The pen may automatically transfer information held on the pen to the base station when it is placed in the base station. By automatically this may mean that it does so without having to wait for a prompt from a user. It may automatically connect to the remote server whenever the pen is placed in the base station, or whenever it receives information from the pen. It could, of course, wait for the user to initiate this.

The pen may have a pressure sensor to determine when the stylus is writing.

The digital writing of markings may be handled by a processor in the pen, the pen being adapted to convey pen-acquired marking data to the base station.

Thus a user may print out a digital document, for example a draft letter, edit it using a digital pen and have a digital version of the edited document created automatically. The printed document may have printed on it a key for determining the identity of the electronic record that was printed. That key may be the allocation of a specified pattern. For example, there may be a pattern-document allocation table created by a computer associated with the printing.

The base station may be arranged such that it can only be configured (or re-configured), with information needed to send the pen information to a remote device, remotely across a network. By this we mean that the base station has no user interface which a user can use to alter the configuration directly at the device. The base station may therefore be provided absent a corresponding user interface, reducing its cost and complexity. With PC based solutions and also mobile telephone based solutions, a complex graphical user interface (GUI) has been needed that prompts the user for information about the remote device, requiring a degree of technical know-how. Indeed in its simplest form operating the device could be as simple as removing it from any packaging it is supplied in, plugging a cable into a telephone socket and starting to write with the pen. This opens use of the device up to a wide range of people who have limited technical ability.

The network used for configuration (or reconfiguration) may be the same telecommunications network as the network used to send out pen information.

Therefore, the processor may be adapted to receive information from across the network which tells the base station how to communicate correctly with a remote device, telephone or service across the network. The base station may send out information by making an ordinary telephone call or establishing an internet connection to the remote device or service.

A button or switch may be provided on the base station which may be operated by a user to initiate configuration of the base station. The switch may be operated or the button pressed when an incoming call is made to the device across the telecommunications network, or prior to the next incoming call or when a user prompt is received. The call, which can be from the appropriate remote device or ISP service, will then connect to the base station.

The base station may receive any one of the following items of information from an incoming call during set-up and configuration:
a telephone number to dial for sending information;
a user account number and/or login;
a password;
modem parameters for communications;
TCP/ICP parameters for connection;
service level parameters for connection.

Where it is a telephone number, this may be the phone number of a server that the device is to send pen information to.

Where it is a user account number or login, this may be an account number needed to access an account that corresponds to the device held on a server. The login may allow the account to be accessed.

In the case of a password, this may be a password which permits the device to send information to a remote server and to receive information back from that server. The password ensures that the transmission of information to and from the server is secure.

In the case of a telephone number, the base station may simply log the incoming number of a configuration call made to the device, the same number being used by the device when sending out pen information.

The base station may be supplied without any details of a remote device to which it is to send pen information, i.e. no phone number or login or password. These may be supplied during a configuration call when it is first used.

Alternatively, it may be supplied preconfigured with an initial configuration which a user can change by requesting an incoming configuration call. In a still further alternative the station may be pre-configured in such a manner that it can not be reconfigured by a user.

The base station may initially be provided with a basic level of set-up that enables it to receive an incoming configuration call, with additional set-up information as above being received later from an incoming call.

The processor may therefore be arranged to be controlled remotely across the telecommunications network to enable the base station to be set up. This allows a low cost device to be produced which is free of the complex user interfaces that are typically needed to set-up devices for connection across a telecommunications network. Eliminating a complex user interface makes the device much simpler to set-up and reduces the cost of the device, as there is no need for a complex display and buttons.

The base station may send out pen information which identifies the pen, and/or a portion of pattern read by the pen and/or the strokes made by the pen representing handwriting.

The base station may be mains powered, or battery powered, or may be arranged to draw all of the power it requires from a telecommunication network connection in the manner of a land line telephone.

According to another aspect the invention provides a base station adapted to receive information from a digital pen comprising a self contained unit which includes a processor, a memory which stores instructions to be executed by the processor and a modem which is arranged to connect the base station to the remote device across the telephone network.

The telephone network is preferably a land based network although other networks may be used, the base station perhaps connecting to a mobile phone and onto a mobile telecommunications network. It could even be connected to a satellite telephone for up linking to a satellite.

The base station may be provided with access using the modem to a digital record of printed content of a document printed on the paper and may be adapted to use the digital record of the printed content and the pen-acquired pen-writing and pen-erasing activity to create a modified digital record of the document incorporating the changes made to the printed document using the pen.

It may be a portable device to which a pen may be docked for charging and/or the transfer of pen information to the base station.

Handwritten markings may be incorporated into the digital version of the printed document as facsimile copies of the physical handwritten markings, or at least some handwritten markings may be interpreted by character recognition software and reproduced in the digital version as typeset characters.

The base station may be compatible with one or more currently available digital pens, such as the Logitech Io (trademark).

The base station may be pre-configured with information required by the base station to connect to a remote device across a telecommunications network. This information may include, for example, a network address of a remote device with which it is to communicate.

According to a still further aspect the invention provides a method of programming a base station according to the second aspect with configuration information comprising connecting to the base station remotely across a network and providing the configuration information needed to configure the device across that network.

It is preferred that the step of providing the information to the base station is performed by a remote device which is arranged to receive pen information from the base station, the configuration information including the location of the remote device on the network. This location information may comprise the telephone number of the remote device on the network.

### BRIEF DESCRIPTION OF THE DRAWINGS

At least one embodiment of the invention will now be described, by way of example only, with reference to the accompanying drawings, of which:

FIG. 1 shows a document suitable for use in a digital pen and paper system;

FIG. 2 shows in detail part of the document of FIG. 1;

FIG. 3 shows a known digital pen suitable for use in a digital pen and paper system;

FIG. 4 shows an embodiment of a digital pen and base station according to at least an aspect of the present invention; and

FIG. 5 is a detailed schematic of the base station of FIG. 4.

### DETAILED DESCRIPTION OF PREFERRED EMBODIMENTS

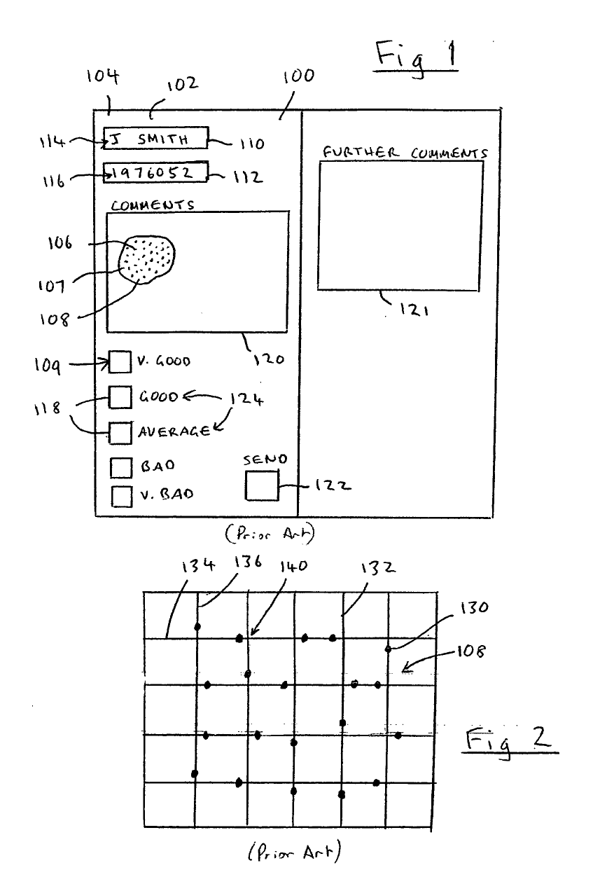

Referring to FIG. 1 a document 100 for use in a digital pen and paper system comprises a carrier 102 in the form of a single sheet of paper 104 with position identifying markings 106 printed on some parts of it to form areas 107 of a position identifying pattern 108. Also printed on the paper 104 are further markings 109 which are clearly visible to a human user of the form, and which make up the content of the document 100. The content 109 will obviously depend entirely on the intended use of the document. In this case an example of a very simple two page questionnaire is shown, and the content includes a number of boxes 110, 112 which can be pre-printed with user specific information such as the user's name 114 and a document identification number 116. The content further comprises a number of check boxes 118 any one of which is to be marked by the user, and two larger boxes 120, 121 in which the user can write comments. The form content also includes a send box 122 to be checked by the user when he has completed the questionnaire to initiate a document completion process by which pen stroke data is forwarded for processing, and typographical information on the form such as the headings or labels 124 for the various boxes 110, 112, 118, 120. The position identifying pattern 108 is only printed onto the parts of the form which the user is expected to write on or mark, that is within the check boxes 118, the comments boxes 120, 121 and the send box 122.

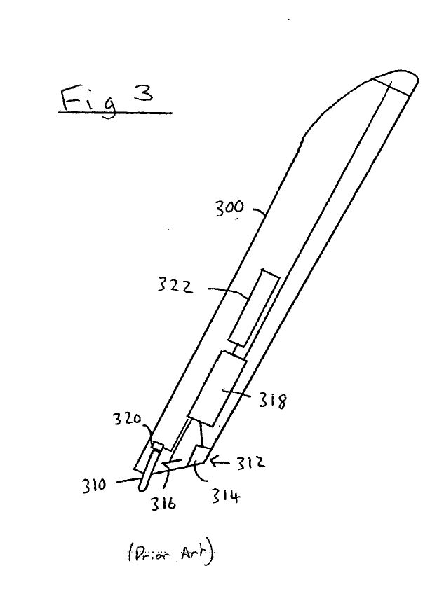

Referring to FIG. 2, the position identifying pattern 108 is made up of a number of dots 130 arranged on an imaginary grid 132. The grid 132 can be considered as being made up of horizontal and vertical lines 134, 136 defining a number of intersections 140 where they cross. One dot 130 is provided at each intersection 140, but offset slightly in one of four possible directions up, down, left or right, from the actual intersection 140. The dot offsets are arranged to vary in a systematic way so that any group of a sufficient number of dots 130, for example any group of 36 dots arranged in a six by six square, will be unique within a very large area of the pattern. This large area is defined as a total imaginary pattern space, and only a small part of the pattern space is taken up by the pattern on the document 100. By allocating a known area of the pattern space to the document 100, for example by means of a co-ordinate reference, the document and any position on the patterned parts of it can be identified from the pattern printed on it. An example of this type of pattern is described in WO 01/26033. It will be appreciated that other position identifying patterns can equally be used. Some examples of other suitable patterns are described in WO 00/73983 and WO 01/71643.

Referring to FIG. 3, a pen 300 comprises a writing stylus 310, and a camera 312 made up of an infra red (IR) LED 314 and an IR sensor 316. The camera 312 is arranged to image an area adjacent to the tip 311 of the pen stylus 310. A processor 318 processes images from the camera 312. A pressure sensor 320 detects when the stylus 310 is in contact with the document 100 and triggers operation of the camera 312. Whenever the pen is being used on a patterned area of the document 100, the processor 318 can therefore determine from the pattern 108 the position of the stylus of the pen whenever it is in contact with the document 100. From this it can determine the position and shape of any marks made on the patterned areas of the document 100. This information is stored in a memory 322 in the pen as it is being used. When the user has finished marking the document, in this case when the questionnaire is completed, this is recorded in a document completion process, for example by making a mark with the pen in the send box 122. The pen is arranged to recognise the pattern in the send box 122 and determine from that pattern the identity of the document 100. The information stored regarding the location of a user's pen strokes in the memory 320 is transferred to a suitable processor upon the user placing the pen 302 in the send box 122.

The document may comprise simply a sheet of paper with a position determining pattern printed on it (no printed human discernable meaningful content is visible), possibly with the whole area of the sheet of paper covered with pattern. Another alternative is a sheet of paper with pattern but not human discernable content apart from a “send” box or “work complete” box; it may have one or more instruction areas for the pen to read but not extra text associated with pen instructions.

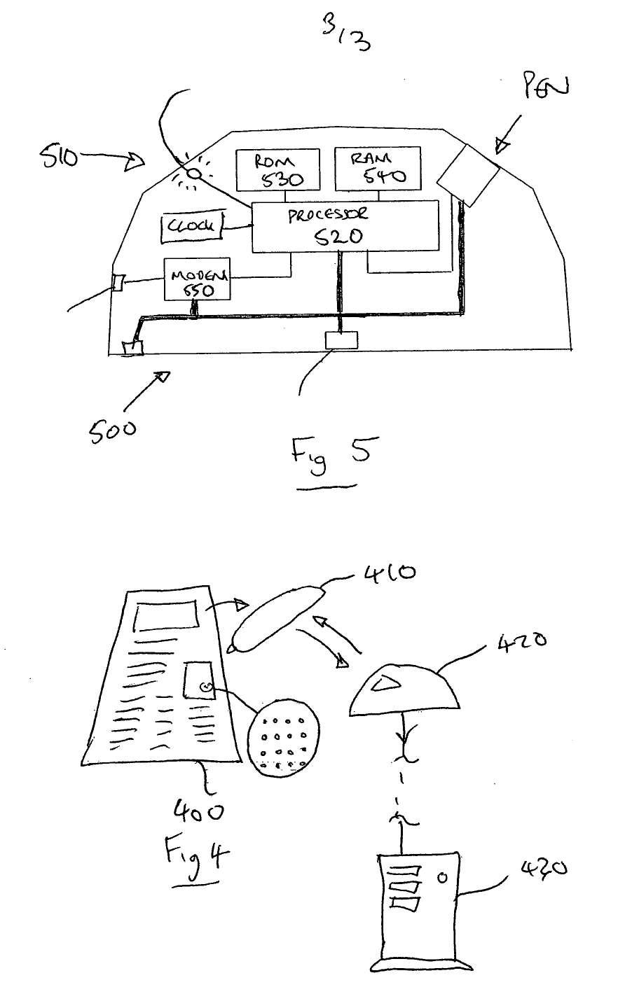

The pen is provided with an output port which comprises at least one electrical contact that connects to corresponding contacts on a base station as shown in FIG. 5 of the accompanying drawings. Also as shown in FIG. 4 the pen reads information from a document 400. The pen (labelled 410 in FIG. 4) transmits positional and status data to the base station 420 contacts on the base station. It may alternatively connect to the base station wirelessly. The base station sends information received from the pen to a remote server 430 across a telecommunication network 440.

As shown in more detail in FIG. 5, a base station 500 comprises a compact, self contained unit 510 housing a dedicated processor 520, an area of read only memory 530 which permanently stores program instructions to be executed by the processor 520, an area of temporary RAM 540 in which information from the pen is stored along with information needed to send out pen information and a modem 550. The memory may store information such as a telephone number and the program instructions cause the modem 550 to dial the number whenever the pen is docked.

The phone number may comprise the address of an internet site which is configured to receive pen information from any base station which accesses it and once a link is made between the base station and the site an acknowledgement instruction is sent back to the base station 500. On receipt of a recognition from the internet site dialled by the modem the processor sends the information to the internet site. On completion the site sends back an acknowledgement and the modem 550 disconnects. A simple display 560 in the base station then displays a message indicating that the transaction is complete.

Of course, in a more basic version the display could be replaced by one or more lights which illuminate to indicate the status of the base station, i.e. power on, charging pen, pen charged, receiving data from the pen, transmitting across the network, transaction complete etc. Even so, the lights provide a far simpler user interface than a PC based system would provide, making it suitable for non-technical users. Notably, with the exception of an optional Power ON/OFF switch or light 570 the device has no other user interface making it a relatively low cost device to manufacture.

The base station 500 may be arranged to transmit data from the pen in real time directly from the pen to the remote server or, alternatively, it may be arranged to transmit stored data from the memory 540 intermittently, in bursts, or when triggered by an event, for example when a user of the pen 400 moves the pen 400 into the send box 122, or when a user docks the pen 400 with the remote processor 424 to allow communication between them.

The base station 500 may initially be supplied with a simple cut-down configuration which permits it to receive an incoming call from a telecommunications network. On first using the device, a user simply plugs the device into a power supply and connects it to a network.

Before it can be used, the device 500 has to be configured so that it knows where to send information to and in what form. The base station illustrated in the accompanying drawings can only be configured remotely across the network 440. The device itself does not provide any form of user interface enabling this to be performed directly. The configuration information is received in one or more incoming calls from a remote device such as a server. Importantly, this removes the need for a complex user interface on the base station 500 and makes set-up suitable for users with a very low level technical ability. It also enables the device 500 to be made smaller.

The incoming configuration call must be directed to the device and this can be achieved in many ways. In a simple solution the device always answers any incoming calls from the network 440. The device of the device may then provide the telephone number of the device to a configuration server or an operator of a configuration service connected to the network. The server or operator calls the number of the device which then automatically connects. The device is then configured across the network by the server or service which could be a manual or automated process.

If the device can not be permitted to pick up all incoming calls, for example when it shares a network connection with other devices such as telephones or fax machines, another way of connecting to the device is needed. In one example, the user may press a button on the device which tells it to receive the current incoming call, or it may default to receive the next incoming call, or perhaps receive a call whilst the button remains depressed. The user can then initiate an incoming call from a server or service as before, perhaps by making a call to an operator of the service company that provides a set-up service for the base station, requesting that they call the base station by return to make the set-up and giving the phone number of the device. Once the user hangs up the operator will call the device across the network.

During the incoming call, however it is made, the base station 500 may be configured or otherwise set-up remotely. The call may send to the base station a phone number that it needs to dial when sending out pen information, or a password or a login. It may also configure the modem 550 of the base station 500 for optimal performance across the network 440. Since this is performed without any input from the user, other than initiating set-up, it is very simple and easy for the user.

It will be appreciated that the server or service that performs the configuration may be the same server or service to which the device sends the pen information once it has been configured.

Once set-up is complete the base station 500 is ready to use. Information from the pen 300 will be sent by the modem 550 of the base station 500 to a telephone, or remote device or ISP or other service across a telephone network 440 automatically. The telephone number placed in the base station memory during set-up will be used to make the connection.

Of course, it may be supplied with all the set-up completed and not have the facility to be re-configured remotely. This would produce an even simpler device but would be limited in its versatility. A compromise that would be to provide it within an initial set-up built-in for a particular service (e.g. a particular phone number for that service) whilst allowing a user to change the service remotely should they wish to change services.

The pen and base station may have a wide variety of uses. In one envisaged use, a digitally recorded document such as a menu or order form may be provided with regions of pattern in tick boxes. A user may tick the box to select an item associated with it. In the case of a menu the user may tick boxes next to food items they wish to order. The pen stores the pattern of markings. When the user has finished selecting from the menu the pen in placed on the base station. The pen information may then be sent by the base station across the telecommunications network to a printer through a telephone to telephone connection, or to a server of an ISP provider by an internet connection and ultimately to a service which is operated by the owner of the restaurant. From the received information the owner can tell what the customer has ordered, and the customer can tell that the order has been accepted by the status of the display or lights on the base station.

A user may have his/her own base station which is to be used with their own pen. It is envisaged that base stations could be provided in all kinds of locations such as shops and restaurants, bars and airports and the like which the user can dock their pen on. If the pen sends an ID to the base station identifying the owner it does not matter which base station is used. Different base stations may connect to their own servers across different networks, allowing the owner of the base station to select where the pen information is to be sent to.

Digital documents that can be read by the pens may be printed out on demand by a user using a local printer (e.g. ink jet or laser printer, or LEP or other printer) or may be pre-printed, perhaps using an offset printing process.

It will be appreciated that whilst our currently preferred embodiment of the invention uses a camera to capture position-determining markings printed on a sheet, typically paper, other embodiments may have their pen and/or eraser, or combined pen and eraser, determine their positions in some other way, for example using gyroscopes, accelerometers, and dead-reckoning from a start point on the document.

The base station may be arranged to work with any one of a range of known digital pens, such as that sold under the name Logitech Io. Alternatively, a range of base stations and dedicated pens may be provided which are specific to a particular base station either in the way that the pen is charged or information is based to or from the pen to the base station.

1. A digital pen and paper system comprising:
a digital pen adapted to acquire information from a position-determining pattern printed on a carrier, and
a base station which is arranged to receive information from the pen and to send the information across a telecommunications network to a remote device, the base station comprising a portable, self contained unit, having a housing which contains a dedicated processor, memory which stores instructions to be executed by the processor and information indicating the location of the remote device on the network, and a modem which is arranged to connect the base station to the remote device across a land-based telephone network.

2. The digital pen and paper system of claim 1, which is arranged to be provided without an interface for direct configuration of the device with the information needed to send the pen information to the remote device.

3. The digital pen and paper system of claim 1 in which the base station is arranged such that it can only be configured, with information needed to send the pen information to a remote device, remotely across the network.

4. The digital pen and paper system of claim 3 in which the base station receives the configuration information from the remote device which it is to send pen information to.

5. The digital pen and paper system of claim 1 in which the memory of the base station is preconfigured with information needed to send the pen information to a remote device across the network.

6. The digital pen and paper system according to claim 1 in which the base station also includes a communication means which enables the station to receive the digitally captured handwritten markings from the pen.

7. The digital pen and paper system of claim 6 in which the pen is arranged to automatically transfer information held on the pen to the base station when it is placed in the base station.

8. The digital pen and paper system of claim 1 in which the device is an integral unit which includes a unit with which the pen can dock together with a cable for connection to a power supply and a cable for connection to a telecommunications network.

9. The digital pen and paper system of claim 8 in which the base station comprises a charger for the pen, with the pen including one or more rechargeable batteries.

10. A base station adapted for use with a digital pen, the base station comprising a self contained unit which includes a dedicated processor for receiving information from the pen, a memory which stores instructions to be executed by the processor and a modem which is arranged to connect the base station to a remote device across a telecommunications network.

11. A base station according to claim 10 which is arranged such that it can only be configured, with information needed for connection to the remote device, remotely across the network.

12. A base station according to claim 11 which is preconfigured with information needed for connection to the remote device, remotely across a network.

13. The base station of claim 11 which includes in its memory an address indicating the location on the network of a digital record of printed content of at least one document.

14. The base station of claim 10 in which the processor, the memory and the modem are contained within a palm-sized housing.

15. The base station of claim 10 in which the program instructions are stored in an area of permanent memory in the base station.

16. A method of programming a base station according to claim 10 with configuration information comprising connecting to the base station remotely across a network and providing the configuration information needed to configure the device across that network.

17. The method of claim 16 in which providing the information to the base station is performed by a remote device which is arranged to receive pen information from the base station, the configuration information including the location of the remote device on the network.
